(19) United States
(12) Patent Application Publication
(10) Pub. No.: US 2025/0343403 A1
(43) Pub. Date: Nov. 6, 2025

(54) STATIONARY VEHICLE BATTERY CHARGER CABLE MANAGEMENT ASSEMBLY

(71) Applicant: BorgWarner Inc., Auburn Hills, MI (US)

(72) Inventors: Dale Smith, Freeville, NY (US); Daniel Scales, Dryden, NY (US); Lorenzo Caprotti, Vimercate (IT)

(21) Appl. No.: 18/654,234

(22) Filed: May 3, 2024

(51) Int. Cl. H02G 11/00; B60L 53/30; H02J 7/00

(52) U.S. Cl. CPC H02G 11/006; B60L 53/30; H02J 7/0042

(57) ABSTRACT

A charging cable management assembly can be part of a stationary vehicle battery charger for furnishing charge to vehicle batteries of battery electric vehicles (BEVs), as an example application. In an implementation, the charging cable management assembly has a cable support arm and a spring. The cable support arm moves about a pivot relative to an associated stationary vehicle battery charger during use. The cable support arm can move between a home position and a fully deployed position, as well as to less-than-fully deployed positions therebetween. The spring exerts a return biasing force to the cable support arm for bringing the cable support arm back to its home position after deployment and for keeping it there.

### TECHNICAL FIELD

The present application relates to battery electric vehicles (BEVs) and, more particularly, to stationary vehicle battery chargers that provide charge to vehicle batteries of BEVs.

### BACKGROUND

Sales of battery electric vehicles (BEVs) are increasing each year and a larger percentage of roadgoing BEVs can benefit from stationary charging. With the increase in BEV sales, businesses and governmental agencies will increase the availability of stationary vehicle battery chargers to offer charging for the batteries equipped in the BEVs. As drivers transition from fuel pumps for fueling internal combustion engine (ICE) powered vehicles to stationary vehicle battery chargers, the ease with which the BEVs can be recharged will be noticed. It would be helpful to increase the ease with which drivers can charge their BEVs with the stationary vehicle battery charger.

### SUMMARY

In an implementation, a charging cable management assembly for a stationary vehicle battery charger is provided. The charging cable management assembly may include a cable support arm and a spring. The cable support arm can be moved relative to the accompanying stationary vehicle battery charger about a pivot. The cable support arm can be moved about the pivot between a home position and a fully deployed position. The spring exerts a return biasing force to the cable support arm. During use, when the cable support arm is moved a first extent from its home position, a first return force is applied at the cable support arm by way of the return biasing force of the spring. Also, during use, when the cable support arm is moved a second extent from its home position, a second return force is applied at the cable support arm by way of the return biasing force of the spring. In this implementation, the first return force has a greater magnitude than that of the second return force, and the first extent has a lesser value than that of the second extent.

In another implementation, a charging cable management assembly for a stationary vehicle battery charger is provided. The charging cable management assembly may include a cable support arm, a lever arm, a spring, and a connector. The cable support arm can be moved relative to the accompanying stationary vehicle battery charger about a pivot. The lever arm extends from the cable support arm, and has a slot residing therein. The spring exerts a return biasing force to the cable support arm by way of the lever arm. The connector extends from the spring. The connector moves along the slot when the cable support arm moves about the pivot. During use, when the cable support arm is moved to a steady deployed position, a return force is lacking and absent at the cable support arm due to the return biasing force of the spring being exerted at the pivot of the cable support arm.

In yet another implementation, a charging cable management assembly for a stationary vehicle battery charger is provided. The charging cable management assembly may include a cable support arm, a lever arm, a spring, and a connector. The cable support arm can be moved relative to the accompanying stationary vehicle battery charger about a first pivot. The cable support arm can be moved about the first pivot between a home position and a fully deployed position. The lever arm extends from the cable support arm, and has a slot residing therein. The spring exerts a return biasing force to the cable support arm by way of the lever arm. The spring can be moved relative to the accompanying stationary vehicle battery charger about a second pivot. The connector extends from the spring, and carries a roller. The roller rides in the slot when the cable support arm moves about the first pivot.

### BRIEF DESCRIPTION OF THE DRAWINGS

FIG. 1 is a perspective view of an embodiment of a charging cable management assembly that is equipped atop a stationary vehicle battery charger;

FIG. 2 is another perspective view of the charging cable management assembly;

FIG. 3 is an enlarged view of the charging cable management assembly, depicting an embodiment of a cable support arm of the charging cable management assembly residing in a home position;

FIG. 4 is an enlarged view of the charging cable management assembly, depicting the cable support arm residing in a fully deployed position;

FIG. 5 is an enlarged view of the charging cable management assembly, depicting the cable support arm residing in the fully deployed position;

FIG. 6 is a perspective view of an embodiment of a spring and a connector of the charging cable management assembly;

FIG. 7 is a partial view of the cable support arm; and

FIG. 8 is a graph depicting user input force to rotate the cable support arm, presenting cable support arm rotational position in degrees (deg) on an x-axis and user input force in pound force (lbf) on a y-axis.

### DETAILED DESCRIPTION

Embodiments of a charging cable management assembly 10 with enhanced ease of use are presented in the figures and detailed in this description. Unlike past devices in which a spring force grew somewhat swiftly as an arm's deployment distance grew, a return force applied at a cable support arm 12 of the charging cable management assembly 10 and observed by a user can increase only slightly with increased arm movement, can remain substantially constant with increased arm movement, can decrease with increased arm movement, or can experience a combination of these effects. The return force serving to bring and maintain the cable support arm 12 in a home position is minimized in the charging cable management assembly 10, reducing effort needed by a user when manipulating a charging cable suspended by the cable support arm 12. A more readily deployable and more readily returned cable support arm and charging cable is hence furnished via the charging cable management assembly 10. Overall, the charging cable management assembly 10 can be easier to use compared to past devices. Varying battery electric vehicle (BEV) types (e.g., buses, trucks, passenger cars) and varying charge port locations can be serviced by the charging cable management assembly 10.

The charging cable management assembly 10 supports a length of an associated charging cable C and swings with the charging cable C as it is pulled to varying locations by a user for charging purposes. Usable length is added to the charging cable C in this way. The charging cable management assembly 10 then self-returns to its home position via spring bias. The self-return can be automatic once use of the charging cable C is completed. Due to its design and construction, minimized effort is required of the user when articulating an arm of the charging cable management assembly 10 amid cable manipulation and minimized spring bias is observed by the user upon self-return of the charging cable management assembly 10. The charging cable management assembly 10 can have various designs, constructions, and components in various embodiments depending upon —among other potential factors—the stationary vehicle battery charger in which the charging cable management assembly 10 is installed and the intended parameters of its self-return capabilities. In the embodiment of the figures, the charging cable management assembly 10 includes, as some of its primary components, the cable support arm 12, a lever arm 14, a spring 16, and a connector 18; still, more, less, and/or different components are possible in other embodiments.

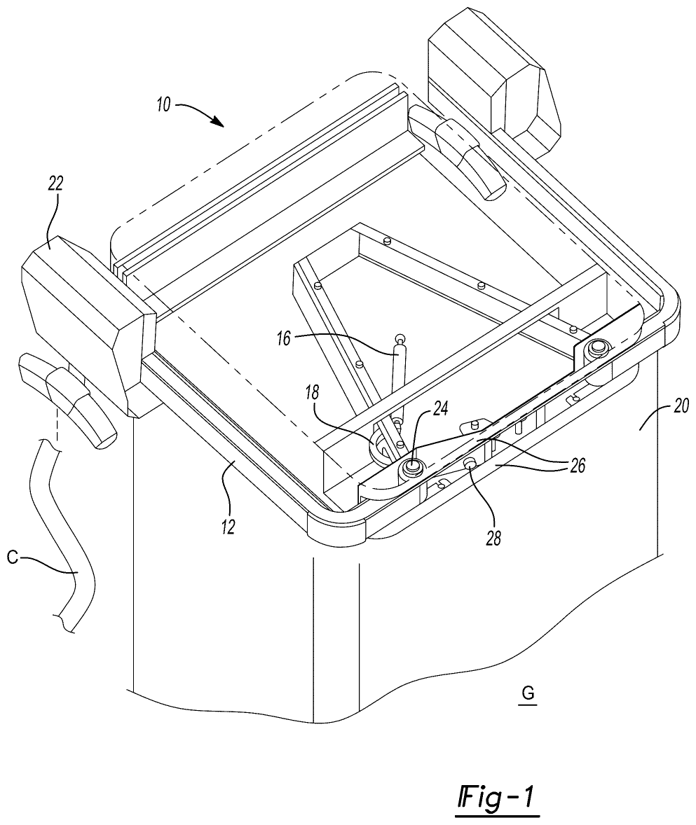

With reference to FIG. 1, in installation the charging cable management assembly 10 can be equipped atop a stationary vehicle battery charger 20. The stationary vehicle battery charger 20 is itself situated on a local ground G that can be located in a vehicle garage, a bus/truck depot, or in a vehicle parking lot, as some example locations. In general, the stationary vehicle battery charger 20 can receive AC electrical power from an electrical grid, rectify the AC electrical power into DC electrical power, and deliver the DC electrical power to the BEV subject to battery charging.

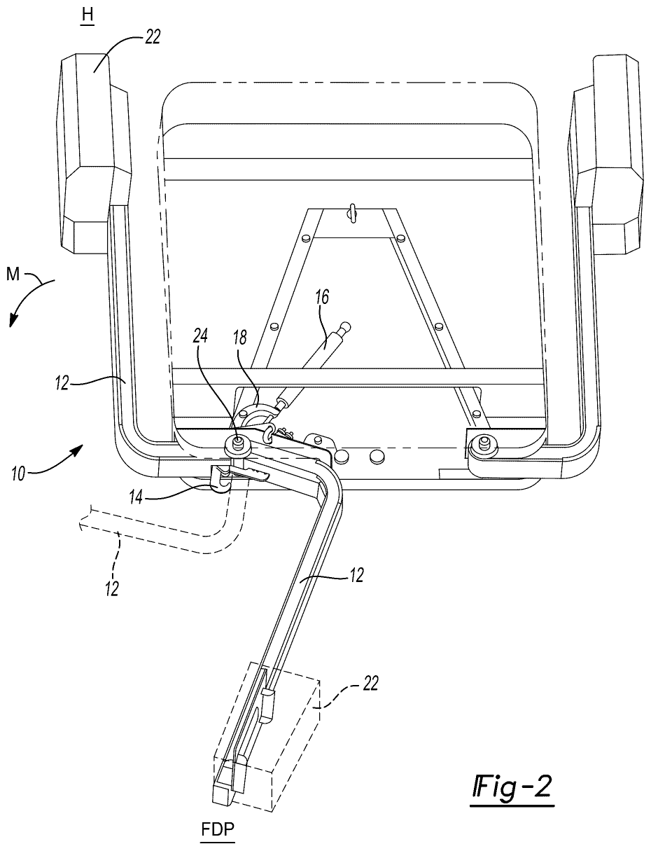

The cable support arm 12 serves to suspend the associated charging cable C above the local ground G and carry its length and weight over the suspension, allowing a user to more readily manipulate the charging cable C amid use. The design, construction, arrangement, and components of the cable support arm 12 can vary in different embodiments. Depending on the embodiment, the cable support arm 12 can directly support the charging cable C, or as illustrated in the figures can be equipped with a cable retractor 22 carried by the cable support arm 12 that can retract and wind-in any slack of the charging cable C. There can be a pair or more cable support arms 12 with the self-return components and functionality in the charging cable management assembly 10, or there can be a single cable support arm 12 in the charging cable management assembly 10, depending on the embodiment. With reference to FIGS. 1 and 2, in this embodiment the cable support arm 12 has an L-shaped configuration. At a proximal end, the cable support arm 12 has a single pivot 24 about which it moves with respect to the stationary vehicle battery charger 20. The cable support arm 12 can be attached via the pivot 24 to a housing or frame 26 of the charging cable management assembly 10 or of the stationary vehicle battery charger 20, or can be attached to another structure, per various embodiments. The attachment can be by nut and bolt fastening or some other way. Movement here is a swinging and rotational movement M (FIG. 2) about the hinged end furnished by the pivot 24. The rotational movement M can be a full one-hundred-and-eighty degrees (180°) arc motion from beginning to end, or can exhibit movement of another extent that is lesser or greater in value. Bearings can be disposed at the pivot 24 to facilitate this motion. Further, at a distal end, the cable support arm 12 carries the cable retractor 22.

When moved amid use, the cable support arm 12 can be moved between a home position H and a fully deployed position FDP, and to a multitude of less-than-fully deployed positions therebetween. The home position H is shown in FIGS. 1, 2, and 3. In this position the cable support arm 12 lacks deployment and is stowed adjacent the housing of the charging cable management assembly 10, yet the charging cable C remains accessible by a user in the home position H. The self-return capabilities of the charging cable management assembly 10, when exhibited, tend to urge the cable support arm 12 to the home position H so that when not in use, or when use ceases, the cable support arm 12 rests and remains in the home position H. User effort and input force is needed in order to bring the cable support arm 12 out of the home position H. The home position H can represent zero degrees) (0° of rotational movement M of the cable support arm 12, according to this embodiment. The fully deployed position FDP constitutes an opposite position of the cable support arm 12 relative to the home position H, and is a maximum rotational movement of the cable support arm 12. The fully deployed position FDP is shown in FIGS. 2 and 4. A hard stop 28 can preclude further movement of the cable support arm 12. The fully deployed position FDP can represent 180° of rotational movement M of the cable support arm 12, according to this embodiment; still, other degrees of rotational movement are possible in other embodiments. Further, between the home position H and fully deployed position FDP, the cable support arm 12 can be moved to numerous extents and to numerous less-than-fully deployed positions. One example of such a position is illustrated partially in broken lines in FIG. 2. The less-than-fully deployed positions can have rotational movements M that are greater than 0° and less than 180°, according to this embodiment; still, other degrees of rotational movement are possible in other embodiments.

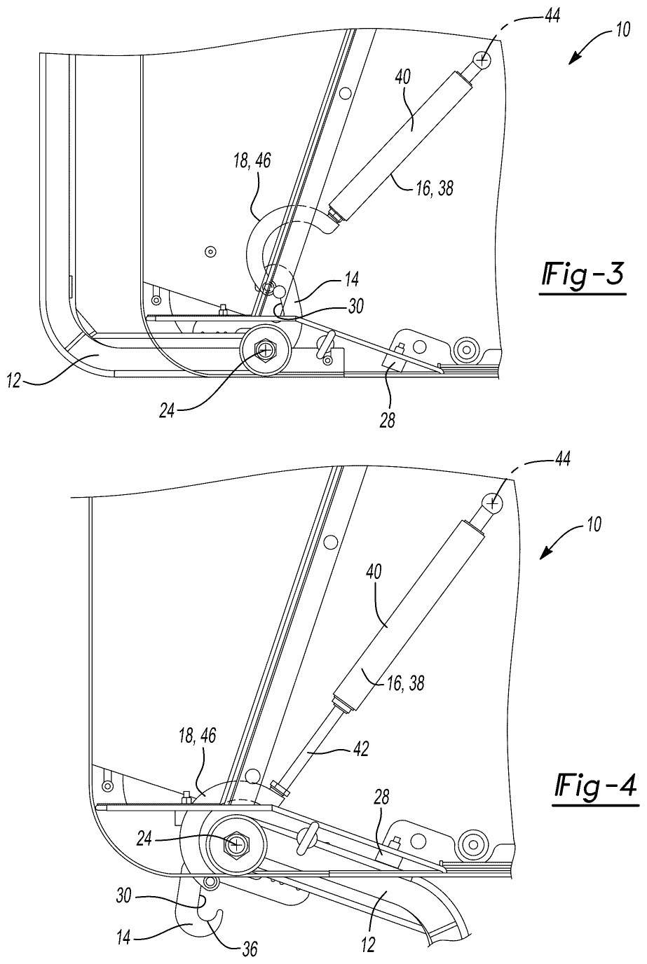

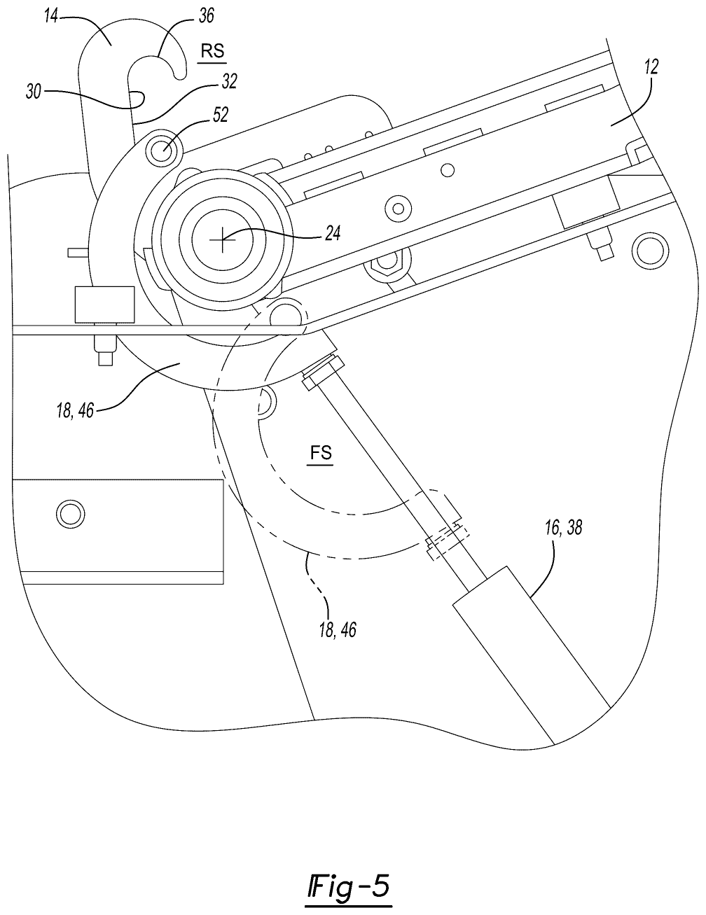

The lever arm 14 serves to magnify a return biasing force exerted by the spring 16 to the cable support arm 12 and can vary a return force applied at the cable support arm 12 depending on the position of the cable support arm 12. The design, construction, arrangement, and components of the lever arm 14 can vary in different embodiments. With reference to FIGS. 3, 4, 5, and 7, the lever arm 14 extends from the cable support arm 12 adjacent the pivot 24 and adjacent the proximal end thereof. The lever arm 14 is situated with respect to the pivot 14 in order to effect the intended leverage from the spring 16 and to the cable support arm 12. The lever arm 14 is fixed relative to the cable support arm 12 and hence moves about the pivot 24 as the cable support arm 12 is caused to move about the pivot 24. Attachment between the lever arm 14 and cable support arm 12 can be carried out in various ways including, but not limited to, welding, bolting, or as a unitary extension. In an embodiment, the lever arm 14 is a plate-like metal structure. A slot 30 resides at, and is defined by, the lever arm 14. The slot 30 accepts reception of the connector 18, and the connector 18 moves along and within the slot 30 amid movement of the cable support arm 12. The slot 30 can exhibit an oval shape (e.g., FIG. 7), can have a hook-like and somewhat curved extent (e.g., FIG. 5), or could have some other shape. As illustrated in FIG. 7, a longitudinal extent L₁ established by the slot 30 has a generally orthogonal relationship and arrangement vertically with respect to a longitudinal axis L₂ of the pivot 24 (vertical as used here is up and down in the figure). In this embodiment, the slot 30 is defined in part by a working surface 32 of the lever arm 14. The working surface 32 has an elongated and linear extent between a first terminal and closed end 34 and a second terminal and closed end 36. The first end 34 is situated closer to the pivot 24, while the second end 36 is spaced from the first end 34 and situated farther from the pivot 24.

In this embodiment, when the cable support arm 12 is in its home position H, the connector 18 bears against the second end 36 (FIG. 3). And when the cable support arm 12 is in its fully deployed position FDP, the connector 18 bears against the first end 34 (FIG. 4). The connector 18 moves and slides along the elongated and linear extent of the working surface 32 when the cable support arm 12 is brought to its less-than-fully deployed positions in-between the home position H and fully deployed position FDP. The leverage furnished by the lever arm 14 to the cable support arm 12 is at a maximum when the connector 18 bears against the second end 36 and, conversely, is at a minimum when the connector 18 bears against the first end 34. Locations of the connector 18 at the slot 30 closer to and toward the second end 36 increase the leverage furnished by the lever arm 14 and, conversely, locations of the connector 18 at the slot 30 closer to and toward the first end 34 decrease the leverage furnished by the lever arm 14. The full longitudinal length and extent Li of the slot 30 can vary with respect to the full rotational motion M of the cable support arm 12 depending on intended functional attributes of the self-return capabilities of the charging cable management assembly 10 and the intended effect of the return biasing force of the spring 16 and the concomitant user input force prescribed for cable support arm 12 motion, among other potential factors. For instance, the full longitudinal length of the slot 30 need not correspond to the full rotational motion M of the cable support arm 12; that is, the connector 18 can remain bearing against the second end 36 for a certain extent of initial motion of the cable support arm 12 from the home position H, and/or the connector 18 can bear against the first end 34 for a certain extent of ending motion of the cable support arm 12 prior to the cable support arm 12 coming into abutment with the hard stop 28 and before reaching the fully deployed position FDP.

The spring 16 serves to exert the return biasing force to the cable support arm 12 and thereby urge the cable support arm 12 toward the home position H amid at least certain extents of its rotational movement M. The design, construction, arrangement, and components of the spring 16 can vary in different embodiments. In this embodiment, the spring 16 exerts the return biasing force to the cable support arm 12 by way of the connector 18 and by way of the lever arm 14. The spring 16 can vary in type according to different embodiments. With reference to FIGS. 3, 4, and 6, in this embodiment the spring 16 is in the form of a pulling gas spring 38 with a cylinder 40 containing gas pressure that draws an internal piston and accompany rod 42 inward; still, in other embodiments the spring could be a coil spring or some other type of spring. At a proximal end, the spring 16 has a single pivot 44 about which it can move relative to the stationary vehicle battery charger 20 with movement of the cable support arm 12. The spring 16 can be attached at the pivot 44 to the housing or frame 26 of the charging cable management assembly 10 or of the stationary vehicle battery charger 20, or can be attached to another structure, per various embodiments. The attachment can be by bolting or some other way. Movement at the pivot 44 can be a somewhat minor rotational movement about the hinged end furnished by the pivot 44 and as called-for by movement of the cable support arm 12. At a distal end, the spring 16 has attachment with the connector 18. The connector 18 can be fastened to the rod 42 via a nut and bolt fastening or via some other way.

According to this embodiment, the spring 16 exerts varied magnitudes of its return biasing force depending on its extension. In a fully retracted position as shown in FIG. 3, the spring 16 exerts a return biasing force of minimal magnitude. Conversely, in a fully extended position as shown in FIG. 4, the spring 16 exerts a return biasing force of maximum magnitude. And from the fully retracted position towards the fully extended position, the magnitude of the return biasing force exerted by the spring 16 steadily grows and increases in value. The location of the connector 18 at and along the slot 30—and hence the leverage furnished by the lever arm 14—can change in accordance with the retracted and extended positions of the spring 16. Return forces applied at the cable support arm 12 and user input forces prescribed for motion of the cable support arm 12 can be governed by modifications of this arrangement. In an embodiment, for instance, when the spring 16 is in the fully retracted position and the return biasing force exhibits minimal magnitude, the connector 18 bears against the second end 36 providing maximum leverage of the lever arm 14. The connector 18 can remain bearing against the second end 36 for a period of initial extension of the spring's position from the fully retracted position, according to an embodiment. Further, when the spring 16 is in the fully extended position and the return biasing force exhibits maximum magnitude, the connector 18 bears against the first end 34 providing minimal leverage of the lever arm 14. In an embodiment, the connector 18 can come to bear against the first end 34 prior to the spring 16 reaching its fully extended position.

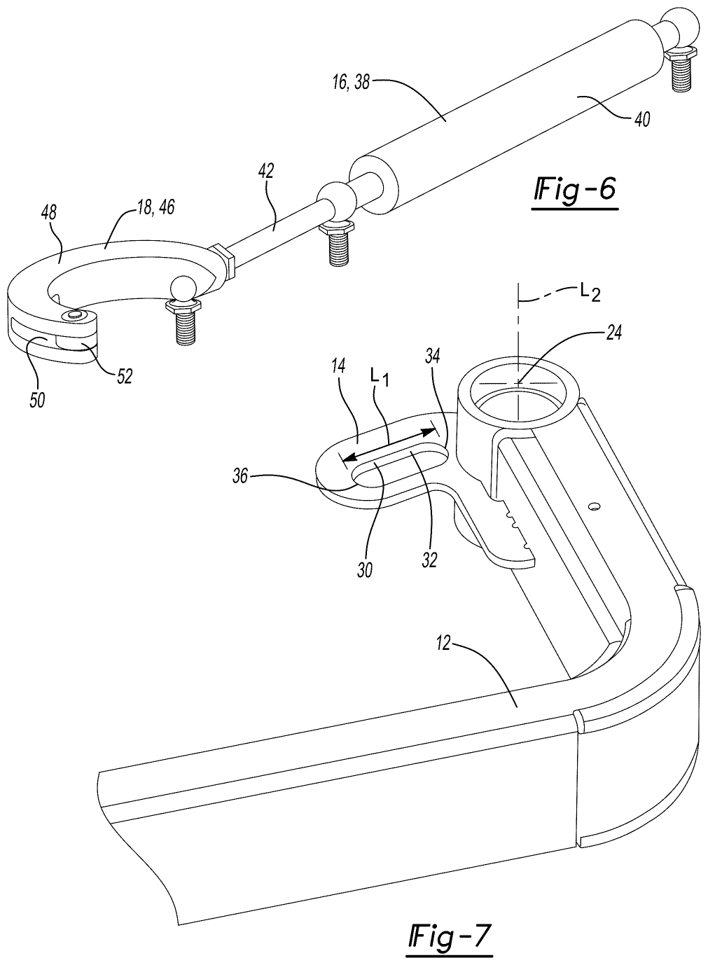

The connector 18 serves to interact with the lever arm 14 and facilitate variance of the return force applied at the cable support arm 12. The design, construction, arrangement, and components of the connector 18 can vary in different embodiments. In this embodiment, and with reference to FIG. 6, the connector 18 extends from the spring 16 and, in effect, can constitute a terminal end thereof. The connector 18 is in the form of a hook connector 46 with a hook-like shape according to this embodiment, but could take other forms and other shapes in other embodiments. A main body 48 of the hook connector 46 resembles an arc. At a proximal end, the connector 18 is attached to the spring 16, and at a distal end, the connector 18 has a slotted clearance 50 and carries a roller 52. The slotted clearance 50 is defined in the main body 48 and spans from the roller 52 and over a section of the hook-like shape. The slotted clearance 50 accommodates reception and insertion of the lever arm 14 for assembling the roller 52 at the slot 30 and as the lever arm 14 moves about the pivot 24 during the rotational motion M of the cable support arm 12. The lever arm 14 moves through the slotted clearance 50 amid the rotational motion M. The roller 52 is seated at the slot 30 and rolls and rides along the working surface 32 of the lever arm 14 between the first and second ends 34, 36. The roller 52 directly abuts and bears against the working surface 32 and can directly abut and bear against the first and second ends 34, 36. The roller 52 can be journaled for rotation at the connector 18. It facilitates movement of the connector 18 along the slot 30.

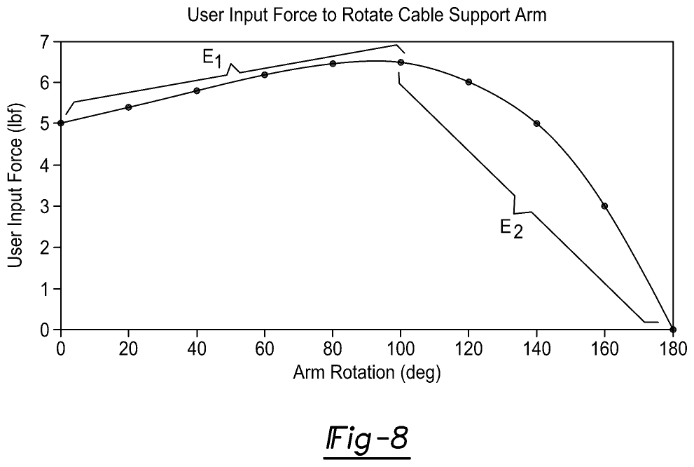

During use of the charging cable management assembly 10, and according to this embodiment, return forces applied at the cable support arm 12 do not experience a swift growth as in past devices, and rather increase slightly and decrease to zero as the cable support arm 12 moves over its full range of motion from the home position H and to the fully deployed position FDP. The user input force needed to impart the rotational movement M of the cable support arm 12 exhibits a similar and corresponding behavior—that is, it increases slightly for an extent of movement and decreases to zero for a subsequent extent of movement. This is depicted in the graph of FIG. 8. The graph represents an estimation of user input force exerted in order to cause the rotational movement M of the cable support arm 12; still, other embodiments of the charging cable management assembly could yield other behaviors and other estimations. In the graph, at zero degrees) (0° of arm rotation, the cable support arm 12 is in the home position H, and at one-hundred-and-eighty degrees (180°) of arm rotation, the cable support arm 12 is in the fully deployed position FDP. Arm rotations greater than (>) 0° and less than (<) 180° denote intervening positions and movement extents of the cable support arm 12 between the home position H and fully deployed position FDP. For example, rotational movement M of the cable support arm 12 would be midway between the home position H and fully deployed position FDP at 90° of arm rotation. As illustrated in the graph, over an extent E₁ of about 100° of arm rotation from the home position) (0°), the user input force increases slightly from about 5 pound force (lbf) to about 6.5 lbf. Then, over a subsequent extent E₂ from 100° of arm rotation to the fully deployed position FDP (180°), the user input force decreases to zero.

Indeed, at the fully deployed position FDP, according to this embodiment there is an absence of a return force applied at the cable support arm 12. In other words, the self-return capabilities of the charging cable management assembly 10—effective at other positions—is altogether lacking at the fully deployed position FDP. The cable support arm 12 can hence remain at the fully deployed position FDP without user input force. This state can constitute a steady deployed position. The steady deployed position can be carried out in varying ways according to different embodiments. In the embodiment of the figures, and referring to FIG. 4, the absence of a return force applied at the cable support arm 12 is effected by exertion of the spring's return biasing force at and through the pivot 24. The return biasing force is hence borne by, and effectively pulled through, the pivot 24 and the attachment of the cable support arm 12 rather than the lever arm 14. Movement of the pivot 24 is constrained with respect to the stationary vehicle battery charger 20, thereby precluding application of the return biasing force to the cable support arm 12. A balancing of spring force is established in this way. The configurations of the lever arm 14 and the connector 18 and their interactions with each other facilitate the provision of the steady deployed position. The swinging motion of the lever arm 14 about the pivot 24 brings the roller 52 to an opposite side of the pivot 24 relative to the spring 16 and relative to the spring's pivot 44. The hook-like shape of the connector 18 also helps bring the roller 52 around to the opposite side of the pivot 24. The opposite side of the pivot 24 can be a rearside RS (FIG. 5) with respect to the spring 16 and its pivot 44, while the other side of the pivot 24 in more direct confrontation with the spring 16 can be a frontside FS (FIG. 5). Still, in other embodiments, the steady deployed position could be provided at other arm rotations and other positions of the cable support arm 12 apart from the fully deployed position (FDP), or need not be provided at all. In an example, the steady deployed position could be provided prior to the cable support arm 12 reaching its fully deployed position FDP.

Furthermore, in an embodiment the charging cable management assembly 10 can implement a remain force applied at the cable support arm 12 via the return biasing force of the spring 16. The remain force would serve to bias the cable support arm 12 to the fully deployed position FDP. In this embodiment, the remain force is effected by exertion of the spring's return biasing force beyond the pivot 24 and passed the steady deployed position and passed the balancing of spring force. The remain force pulls the cable support arm 12 against the hard stop 28 and toward the fully deployed position FDP, and maintains the cable support arm 12 in that position. In order to then bring the cable support arm 12 out of the fully deployed position FDP, the user needs to impart an input force to the cable support arm 12 to overcome the remain force and hence prompt return of the cable support arm 12 to the home position H.

Still, the charging cable management assembly could have more, less, and/or different components in other embodiments. As an example, the hook connector component could be absent, whereby interaction between the spring and cable support arm could be more direct and more immediate and/or with other types of intermediate constructions. Furthermore, other embodiments could exhibit other behaviors of return force and user input force based on a particular application; for instance, modifications could be made to the design and construction of the spring, lever arm and its slot, and connector in order to adjust the parameters and behavior of the return force and user input force. Yet further, in another embodiment the cable support arm could have a larger range of arm rotation motion that is greater than 180° and intended for servicing both sides of the accompanying stationary vehicle battery charger; here, the cable support arm could be rotated passed a steady deployed position and passed balancing of spring force, in which case the cable support arm could be pulled against a hard stop situated opposite its home position.

As used herein, the terms “general” and “generally” and “substantially” are intended to account for the inherent degree of variance and imprecision that is often attributed to, and often accompanies, any design and manufacturing process, including engineering tolerances—and without deviation from the relevant functionality and outcome—such that mathematical precision and exactitude is not implied and, in some instances, is not possible. In other instances, the terms “general” and “generally” and “substantially” are intended to represent the inherent degree of uncertainty that is often attributed to any quantitative comparison, value, and measurement calculation, or other similar representation.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A charging cable management assembly for a stationary vehicle battery charger, the charging cable management assembly comprising:
a cable support arm moveable about a pivot with respect to the stationary vehicle battery charger, the cable support arm moveable between a home position and a fully deployed position; and
a spring exerting a return biasing force to the cable support arm;
wherein, when the cable support arm is moved a first extent from the home position, a first return force is applied at the cable support arm via the return biasing force of the spring, and when the cable support arm is moved a second extent from the home position, a second return force is applied at the cable support arm via the return biasing force of the spring, the first return force being greater than the second return force, and the first extent being less than the second extent.

2. The charging cable management assembly as set forth in claim 1, wherein, when the cable support arm is moved a third extent from the home position, an absence of a return force is effected at the cable support arm, the third extent being greater than the first extent and greater than the second extent.

3. The charging cable management assembly as set forth in claim 2, wherein the third extent constitutes the fully deployed position.

4. The charging cable management assembly as set forth in claim 2, wherein the absence of the return force is effected via the return biasing force of the spring being exerted at the pivot of the cable support arm.

5. The charging cable management assembly as set forth in claim 1, wherein the first return force is applied at the cable support arm via a lever arm extending from the cable support arm.

6. The charging cable management assembly as set forth in claim 1, wherein, when the cable support arm is at the fully deployed position, a remain force is applied at the cable support arm via the return biasing force of the spring, the remain force biasing the cable support arm to the fully deployed position.

7. The charging cable management assembly as set forth in claim 1, further comprising a lever arm extending from the cable support arm, the spring exerting the return biasing force to the cable support arm via the lever arm.

8. The charging cable management assembly as set forth in claim 7, further comprising a connector extending from the spring, a slot residing at the lever arm, the connector moving along the slot when the cable support arm is moved to the second extent from the home position.

9. The charging cable management assembly as set forth in claim 8, wherein the connector carries a roller, the roller riding in the slot when the cable support arm is moved to the second extent from the home position.

10. The charging cable management assembly as set forth in claim 8, wherein the connector is a hook connector.

11. The charging cable management assembly as set forth in claim 8, wherein the spring is moveable about a second pivot with respect to the stationary vehicle battery charger when the connector moves along the slot.

12. A charging cable management assembly for a stationary vehicle battery charger, the charging cable management assembly comprising:
a cable support arm moveable about a pivot with respect to the stationary vehicle battery charger;
a lever arm extending from the cable support arm, the lever arm having a slot;
a spring exerting a return biasing force to the cable support arm via the lever arm; and
a connector extending from the spring, the connector moving along the slot when the cable support arm moves about the pivot;
wherein, when the cable support arm is moved to a steady deployed position, an absence of a return force is effected at the cable support arm via the return biasing force of the spring being exerted at the pivot of the cable support arm.

13. The charging cable management assembly as set forth in claim 12, wherein, when the cable support arm is moved from a home position thereof and toward a fully deployed position thereof, a reduction in the return force applied at the cable support arm takes place over at least a span of a full extent from the home position to the fully deployed position.

14. The charging cable management assembly as set forth in claim 12, wherein, when the cable support arm is moved a first extent from a home position thereof and toward a fully deployed position thereof, a first return force is applied at the cable support arm via the return biasing force of the spring, and when the cable support arm is moved a second extent from the home position and toward the fully deployed position thereof, a second return force is applied at the cable support arm via the return biasing force of the spring, the first return force being greater than the second return force, and the first extent being less than the second extent.

15. The charging cable management assembly as set forth in claim 12, wherein the connector carries a roller, the roller riding in the slot when the cable support arm moves about the pivot.

16. The charging cable management assembly as set forth in claim 12, wherein the spring is moveable about a second pivot with respect to the stationary vehicle battery charger when the connector moves along the slot.

17. The charging cable management assembly as set forth in claim 12, wherein the connector is a hook connector.

18. A charging cable management assembly for a stationary vehicle battery charger, the charging cable management assembly comprising:
a cable support arm moveable about a first pivot with respect to the stationary vehicle battery charger, the cable support arm moveable between a home position and a fully deployed position about the first pivot;
a lever arm extending from the cable support arm, the lever arm having a slot;
a spring exerting a return biasing force to the cable support arm via the lever arm, the spring being moveable about a second pivot with respect to the stationary vehicle battery charger; and
a connector extending from the spring, the connector carrying a roller, the roller riding in the slot when the cable support arm moves about the first pivot.

19. The charging cable management assembly as set forth in claim 18, wherein, when the cable support arm is moved a first extent from the home position thereof and toward the fully deployed position thereof, a first return force is applied at the cable support arm via the return biasing force of the spring, and when the cable support arm is moved a second extent from the home position and toward the fully deployed position thereof, a second return force is applied at the cable support arm via the return biasing force of the spring, the first return force being greater than the second return force, and the first extent being less than the second extent.

20. A stationary vehicle battery charger comprising the charging cable management assembly as set forth in claim 18.
